(19) United States
(12) Patent Application Publication
(10) Pub. No.: US 2005/0072493 A1
(43) Pub. Date: Apr. 7, 2005

(54) Portable folding table

(76) Inventor: Ali Velasco, Houston, TX (US)

Correspondence Address: LITMAN LAW OFFICES, LTD., P.O. BOX 15035 CRYSTAL CITY STATION, ARLINGTON, VA, 22215, US

(21) Appl. No.: 10/676,112

(22) Filed: Oct. 2, 2003

(51) Int. Cl. B25H 1/00

(52) U.S. Cl. 144/286.1

(57) ABSTRACT

The present portable folding table is particularly well adapted for the installation or attachment of a power tool, such as a router or the like, to the underside of the table surface. The present table includes a folding mechanism which enables a power tool to remain attached to the underside of the table surface, while still allowing the table structure to be folded essentially flat without requiring disassembly or removal of any parts. The table structure provides a storage space between the legs of each leg pair when folded, which allows the folded table top to nest within the storage space. The power tool is deployed outwardly, rather than interfering with the folding operation. A positional adjustment mechanism is also provided, which enables the power tool to be adjusted incrementally in two mutually orthogonal directions.

### BACKGROUND OF THE INVENTION

1. Field of the Invention

The present invention relates generally to relatively small and lightweight folding tables, supports, and similar articles. More specifically, the present invention comprises a folding table for the installation of a router tool therewith. Another type of tool or device may alternatively be used with the present folding table if so desired, with some modification to the table.

2. Description of the Related Art

Power and hand tools used for wood and metal working projects generally require a sturdy and fairly rigid support structure of some sort. Many professional shops, as well as a large number of home workshops, install many of their power tools in permanently installed, non-folding tables, work benches, and other similar structures. Many other such shops, most particularly home workshops where space is at a premium, utilize portable, folding tables and stands to mount many of the tools which might be used in the shop.

Portability provides a number of advantages for both the amateur and professional craftsman. A folding, portable machine tool table provides greater versatility for the home craftsman, in that such a table may be folded and stored when not in use, thus freeing up space for other projects. The professional craftsman may need to travel to various job sites from time to time, and requires portability for his tools and equipment for such work. As a result, a number of folding, portable power tool tables and similar structures have been developed in the past.

Most such portable worktables are lightweight and provide for folding the table for compact storage, which is desired of such devices. However, most utilize relatively conventional folding mechanisms, which result in a relatively bulky packages when such devices are folded. A problem encountered with portable, folding work tables is that the power tool is often attached to the lower surface of the table, with the working blade or bit extending through a passage in the table to cut or work the workpiece which is placed atop the table. With most conventional tables, some accommodation must be made for the bulk of the power tool installed beneath the table when the table is folded.

Many folding tables accomplish this by retaining the table top as a single, non-folding sheet of material, with the table top merely being hinged to one side of the folding legs. This results in a relatively bulky package, when the full width of the table top cannot be reduced by folding. In other cases where the table top is provided with means for folding, the power tool installed thereunder must be removed in order to allow the two leaves to be folded together with their lower surfaces abutting one another. While this folding arrangement can provide for a relatively compactly folded table, it requires the additional step of removing the power tool in order to fold the table flat.

The present invention provides a solution to the above problem with a portable folding table in which the table top is divided into two portions which are hinged together along their adjacent edges. However, rather than folding with their lower surfaces abutting one another, as is done with many conventional folding tables, the table top of the present folding table folds with its upper surfaces abutting. Thus, a power tool installed beneath the table top is not captured between the folded halves of the top, but extends outwardly therefrom and need not be removed from the folding table structure. This greatly simplifies setup and folding of the present table, and greatly reduces the time required for setup and folding operations.

The present invention is primarily intended for use with a router type power tool. Accordingly, a central opening may be provided for a router bit to extend therethrough, and a novel two axis router position adjustment is also provided. This allows the router to be raised for changing cutting blades and fine adjustment of cutting height, and also allows the router to be adjusted toward and away from the table edge to facilitate fine adjustments, rather than requiring the adjustment of a fence atop the table. The result is a table or work stand which greatly facilitates its use and operation, and saves considerable time in setup, use, and folding for the amateur or professional craftsman using the device.

A discussion of the related art of which the present inventor is aware, and its differences and distinctions from the present invention, is provided below.

U.S. Pat. No. 3,554,247 issued on Jan. 12, 1971 to Arild Larsen, titled “Apparatus For Trimming Articles Of Varying Widths,” describes a power planer primarily intended for trimming cedar shakes and similar articles to a predetermined width. The Larsen device includes two cutting heads disposed horizontally opposite one another, with the workpieces being run between the two cutting heads. No folding means for the table top is disclosed by Larsen. Positional control of at least one of the cutting heads is provided, but this control is accomplished automatically, rather than by the operator as in the case of the cutting head adjustment for the present invention.

U.S. Pat. No. 4,186,784 issued on Feb. 5, 1980 to John T. Stone, titled “Tool Table Construction,” describes a relatively small table formed of stamped sheet metal components and having short legs adapted for placement atop an existing work bench or the like. The table top and legs of the Stone table do not fold. The legs must be disassembled from the table top for relatively flat storage of the device, and the table top is a single unit incapable of folding. While Stone provides for the installation of various power tools beneath his table, he does not provide any means for making fine positional adjustments of those tools once they are installed. In contrast, the present folding table may include a set of orthogonal tracks to allow a router or other tool mounted thereon to be adjusted positionally in fine increments in both the vertical and fore—aft directions.

U.S. Pat. No. 5,345,983 issued on Sep. 13, 1994 to Alfredo F. de Abreu, titled “Four Sided Alternating Woodworking Planer With Two Sided Copying System,” describes a relatively complex planer capable of planning multiple surfaces of a workpiece. The device includes a workpiece drive mechanism to advance the workpiece through the machine automatically. The de Abreu machine is quite complex and is intended for professional shop installation and use. As such, de Abreu does not make any provision for portability or folding of his planer machine.

U.S. Pat. No. 5,584,254 issued on Dec. 17, 1996 to Willis R. Williams, titled “Collapsible Work Bench Apparatus,” describes a portable work bench having a conventional X-leg configuration, with the legs being pivotally secured to one another at their respective crossing points. The table top is formed in two separate halves, with each half secured to a respective pair of lateral members. The lateral members are pivotally secured to the upper ends of the opposite legs. The Williams table is folded by lifting each table top half upwardly and swinging it over in approximately a 270 degree arc to hang suspended to the opposite side of the table. The two table top halves end up with their bottom surfaces facing and closely adjacent to one another, when the table is folded. This leaves no room between the two table top halves for a power tool of any sort to remain attached to the structure. In contrast, the table top portions of the present folding table fold with their upper surfaces facing one another, to allow a power tool to remain attached to one side and extend outwardly therefrom.

U.S. Pat. No. 5,863,052 issued on Jan. 26, 1999 to Gregory S. Roman, titled “Collapsible Carpentry Work Station And Push Cart Combination,” describes a work table or bench providing for the installation of a series of different power tools thereon. One end of the device includes a radial saw or other power tool pivotally mounted thereon, with the saw pivoting between the two lateral structural members of the table for storage beneath the table surface. A table saw and router are mounted beneath the table surface, with their blades extending above the surface. The Roman work station does not provide a folding table top or work surface, as does the present invention. Rather, the support legs pivotally fold beneath the table structure and its understructure. The length and width of the folded device remain the same as when the device is deployed for use.

U.S. Pat. No. 6,182,935 issued on Feb. 6, 2001 to Mark S. Talesky, titled “Folding Table For Use With A Table Saw,” describes a folding frame for supporting a table saw and integral table. The frame includes conventional center pivoted legs in an X-pattern which support an upper support surface. The upper support surface does not fold per se, but may be removed from the legs, with the folded legs stored within the frame of the upper support surface. Talesky does not separate a planar table top surface into two components which are pivotally attached to one another and which remain attached to the support legs with their upper surfaces facing one another, as does the present folding work table invention.

U.S. Pat. No. 6,209,597 issued on Apr. 3, 2001 to Hal Calcote, titled “Power Tool Mounting Stand,” describes a work stand for a table saw, radial arm saw, router, or similar power tool. The Calcote work stand provides for adjustment of height, but does not include any means for folding the legs nor for folding the main portion of the table top itself. The only folding means provided, is for a set of opposed extensions to each end of the table top. Moreover, no means is apparent in the Calcote disclosure for adjusting the positions of any of the tools in two axes by means of an orthogonal electromechanical drive system, as provided with the present folding table invention.

U.S. Patent Publication No. 2002/43,296 published on Apr. 18, 2002, titled “Router Tables,” describes various embodiments of a table assembly including a router, multi-piece adjustable fences, feather flaps, miter guide and protractor, dovetail and box joint accessories, and other components. The present portable folding table may incorporate various equivalent components, if so desired, while including the novel folding means and router position adjustment means of the present invention. Daniels et al. do not provide any means of folding the legs of their device relative to the table top thereof. Also, the table top is formed as a single, unitary piece, and cannot be folded for compact storage, as provided by the present portable folding table invention.

U.S. Patent Publication No. 2002/108,481 published on Aug. 15, 2002, titled “Folding Saw Table,” describes a table structure for mounting a circular saw thereon. The table includes opposed folding leg assemblies at each end thereof, as well as extensions which telescope from each end of the table. However, the table top is essentially a single, unitary structure and cannot fold about a central hinge line, as provided in the present folding table structure. Moreover, it is not possible to use the table as a router table or other such table where a power tool is installed beneath the table and left there essentially permanently, due to the inwardly folding legs and cross bracing which extend from and fold beneath the table.

U.S. Patent Publication No. 2002/124,705 published on Sep. 12, 2002, titled “Work Table With A Portable Table Saw Support,” describes a table having opposed folding leg pairs and a pair of arms extending from one end of the table. A table saw may be installed upon the two extension arms. The table top per se is formed as a single, unitary sheet, and cannot fold along its center or any other area. The two opposed sets of legs fold against the bottom surface of the table top, thus precluding the permanent installation of a tool depending below the table.

U.S. Patent Publication No. 2002/179,181 published on Dec. 5, 2002, titled “Portable, Lockable, Folding Work Bench Or Tool Table,” describes a portable table assembly on wheels or casters. The table top is split down the middle, but the two halves are not hinged together as in the present invention. Rather, they are coplanar and may be adjusted toward or away from one another to serve as vise jaws. The outer edges of the table leaves can be folded downwardly, or upwardly to lie atop the central table portions during storage. The support structure beneath the table top can be folded to allow the table top to lie adjacent a lower storage shelf for storage and transport of the unit when it is not in use. However, the underlying storage shelf and relative movement of the two halves of the table top preclude the permanent installation of a power tool beneath the table top.

U.S. Patent Publication No. 2003/41,711 published on Mar. 6, 2003, titled “Hinged Saw Table, System, And Method For Forming And Cutting An Elongate Workpiece,” describes an assembly configured for attachment to one end of a seamless gutter rollforming machine. The attachment is pivotally attached to one end, and holds a circular saw above the extension end to serve as a cutoff saw for the completed gutter as it exits the machine. The saw and its frame may be pivoted up and over the output end of the machine when not in use. No folding table mechanism with the table halves folding between the table legs, nor router mounting providing two dimensional positional adjustment of the router, is provided.

German Patent Publication No. 3,538,529 published on May 7, 1987, describes (according to the drawings and English abstract) a table for a circular saw or other power tool. The tool is secured conventionally to the underside of the table top. However, the table top is pivotally mounted within the frame, to allow the table top to be swung through 180° for access to the surface which is normally the underside of the table top, in order to facilitate the installation and removal of the power tool therefrom. No folding legs or folding halves of the table top are disclosed in the '529 German Patent Publication.

Finally, British Patent Publication No. 2,231,833 published on Nov. 28, 1990, titled “Work Bench,” describes a table configuration closely resembling that of the '254 U.S. Patent to Williams, discussed further above. The Holdaway table includes opposed pairs of X-configuration legs, with the legs pivoting about their connections for folding and deployment. The upper ends of the legs each include a “bearer link” extending therefrom, with each pair of opposed links having a table top half extending across the distal ends thereof. The two table top halves meet along their central edges when the table is deployed, and prevent excessive spreading of the legs. The two table top halves swing through an arc of approximately 270° with their lower surfaces facing one another when the table is folded. This precludes the essentially permanent installation of a power tool beneath the table top, as the two leaves do not provide sufficient room to include a power tool therebetween when the table assembly is folded.

None of the above inventions and patents, taken either singly or in combination, is seen to describe the instant invention as claimed. Thus a portable folding table solving the aforementioned problems is desired.

### SUMMARY OF THE INVENTION

The present portable folding table is configured for securing a router or other power tool beneath the table top thereof, with the blade of the tool extending upwardly through a passage in the table top. The table top is formed in two halves, with the two portions connected by hinges along a lateral centerline. The leg pairs of the table are assembled in generally X-shaped configurations, with the legs being slotted so the pivot point travels during the folding operation to place the legs of each pair in an offset, spaced apart relationship to one another when folded. The two halves of the table top fold inwardly into the space between the legs, with the upper surfaces of the table top halves immediately adjacent and facing one another. This places the router or other power tool installed beneath the table top, to the outside of the assembly where it does not restrict the folding action of the table assembly.

The present folding table is particularly configured for use as a router table. Accordingly, the router is attached in a specially configured bracket or track assembly which provides for both vertical and fore-to-aft positional adjustment of the router. This is preferably accomplished by a low voltage circuit which drives two orthogonally disposed motors which operate jack screws to accomplish the adjustment. A set of switches is provided to control the operation. This arrangement provides considerably finer adjustment than is generally achievable by adjusting a fence or other conventional positional adjustment of such a work table and power tool. The present table may be equipped with various accessories, such as fences, featherboards, circle and oval cutting guides, etc., as desired.

Accordingly, it is a principal object of the invention to provide a portable, folding table wherein the table top comprises two portions, with the two portions being pivotally attached to one another and folding inwardly between the table legs with the upper surfaces of the table top portions immediately adjacent and facing one another when the table is folded, to allow a power tool attached below the table top to extend to the outside of the folded assembly to avoid interference with the table components.

It is another object of the invention to provide such a table in which the leg pairs form X-shaped configurations when the table is deployed, but in which the legs have offset pivots to allow the legs to define a table top storage gap therebetween when folded.

It is a further object of the invention to provide such a table having a router attachment beneath the table top portion thereof, with the router attachment comprising a pair of orthogonally disposed tracks to provide incremental positional adjustment of the power tool in both vertical and fore-to-aft directions, as desired.

Still another object of the invention is to provide such a table in which the router or power tool positional adjustment means is electrically powered, preferably by a low voltage circuit.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a perspective view of a portable folding table according to the present invention, showing its general configuration in a fully deployed state.

FIG. 2 is a slightly inclined front elevation view of the present portable folding table with one table top half folded upwardly to form a fence or to initiate the folding operation.

FIG. 3 is a left side elevation view of the present table in the partially folded configuration shown in FIG. 2.

FIG. 4 is a left side elevation view of the present table, showing the previously upwardly extending leaf folded over the opposite leaf.

FIG. 5 is a perspective view of the present table in its completely folded configuration, showing further details thereof.

FIG. 6 is a side elevation view of the inboard side of one of the guide channel legs of the present table, showing the guide channel formed therein.

FIG. 7 is a detail bottom perspective view of the power tool positional adjustment mechanism which may be incorporated with the present table.

FIG. 8 is an electrical schematic showing the electrical circuit for the operation of the positional adjustment mechanism.

Similar reference characters denote corresponding features consistently throughout the attached drawings.

### DETAILED DESCRIPTION OF THE PREFERRED EMBODIMENTS

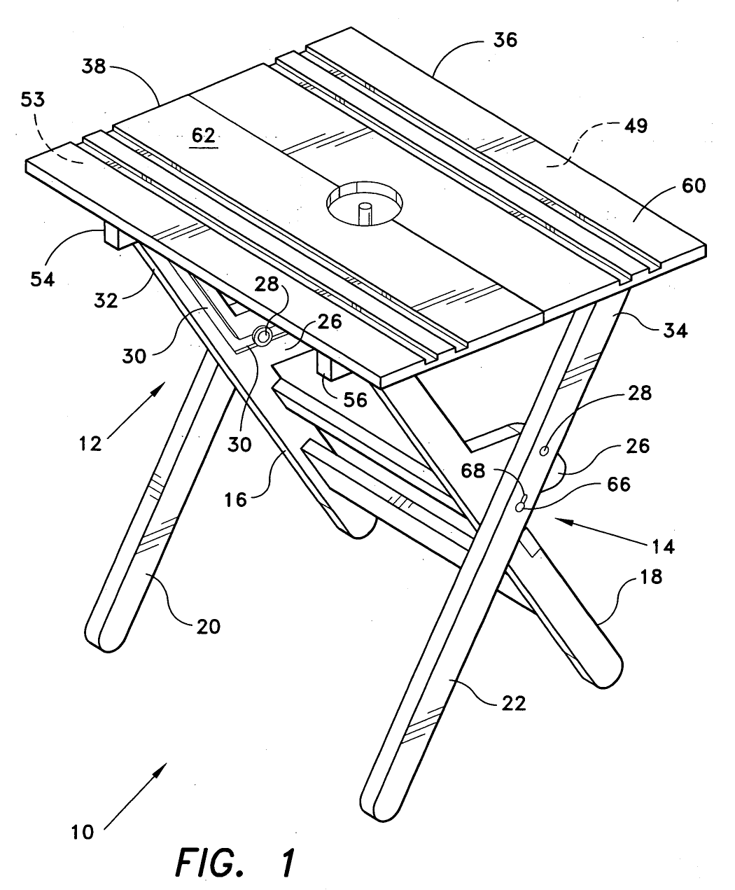

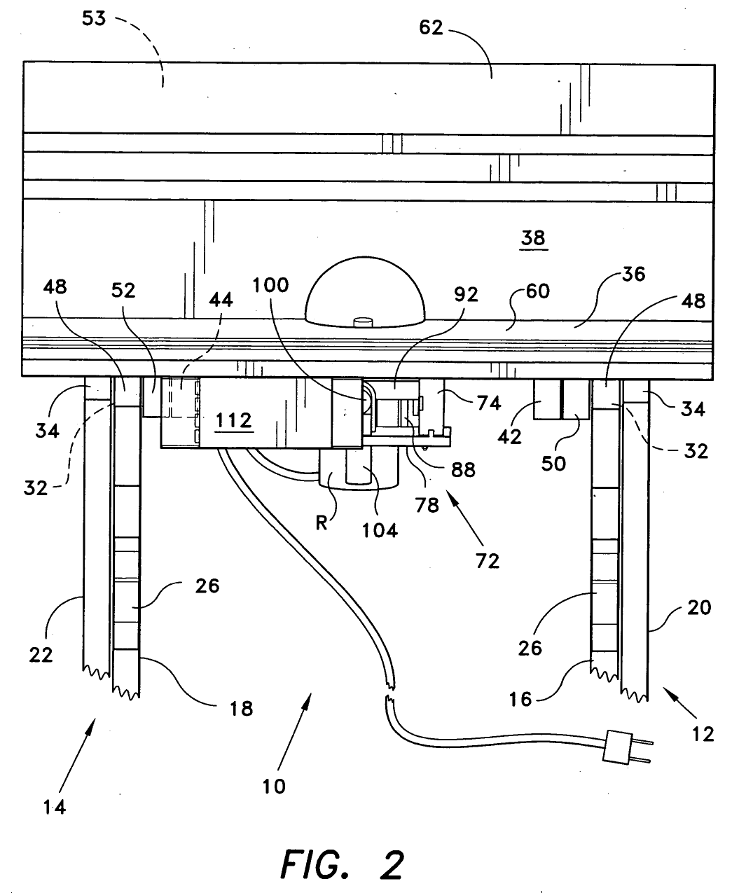

The present invention comprises a folding table configured for use with various types of power tools and providing for their attachment thereto. While other types of power tools may be installed upon the present folding table, its configuration is particularly well suited for use with a router. FIG. 1 of the drawings provides a perspective view of the present folding table 10, with FIGS. 2 through 5 showing the table 10 from various directions in various steps of the folding process. The table top of the table 10 is supported by spaced apart, substantially parallel first and second leg pairs, respectively 12 and 14. Each leg pair 12 and 14 includes a guide channel leg, respectively 16 and 18, and a brace leg, respectively 20 and 22.

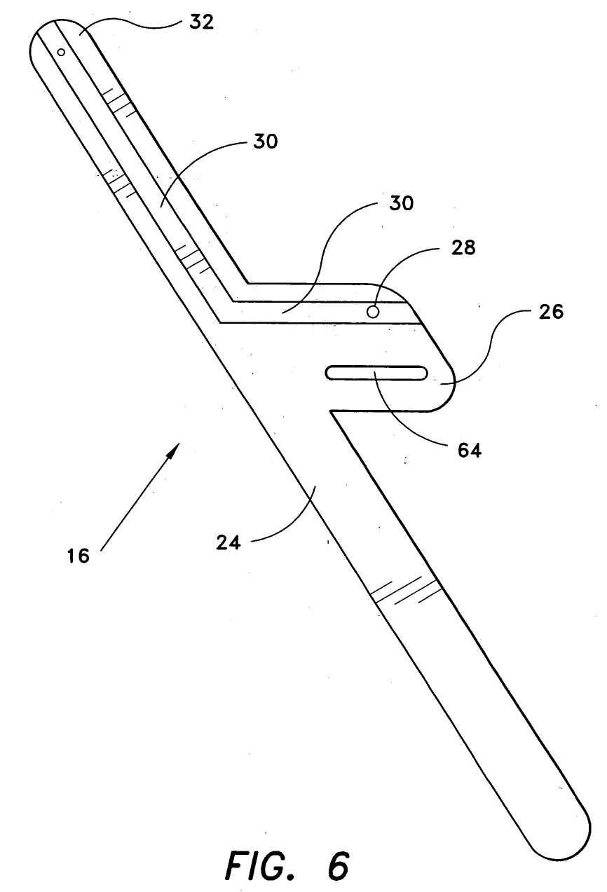

FIG. 6 of the drawings provides a side elevation view of the inside surface 24 of the guide channel leg 16 of the first leg pair 12, with the opposite second guide channel leg 18 being a mirror image of the leg 16 illustrated in FIG. 6. Each guide channel leg, e.g. the first guide channel leg 16 of FIG. 6, includes a laterally offset brace leg attachment extension 26 to which the corresponding brace leg 20 or 22 is attached pivotally by a pivot pin 28, as shown in FIGS. 1, 3, and 4. A guide channel 30 extends from the table top support end 32 of each guide channel leg 16 and 18, along the leg to a point adjacent the brace leg extension 26, thence turning to extend across the brace leg attachment extension 26, as shown in detail in the guide leg 16 of FIG. 6. The function of the guide channels 30 of each of the guide channel legs 16 an 18 is explained further below.

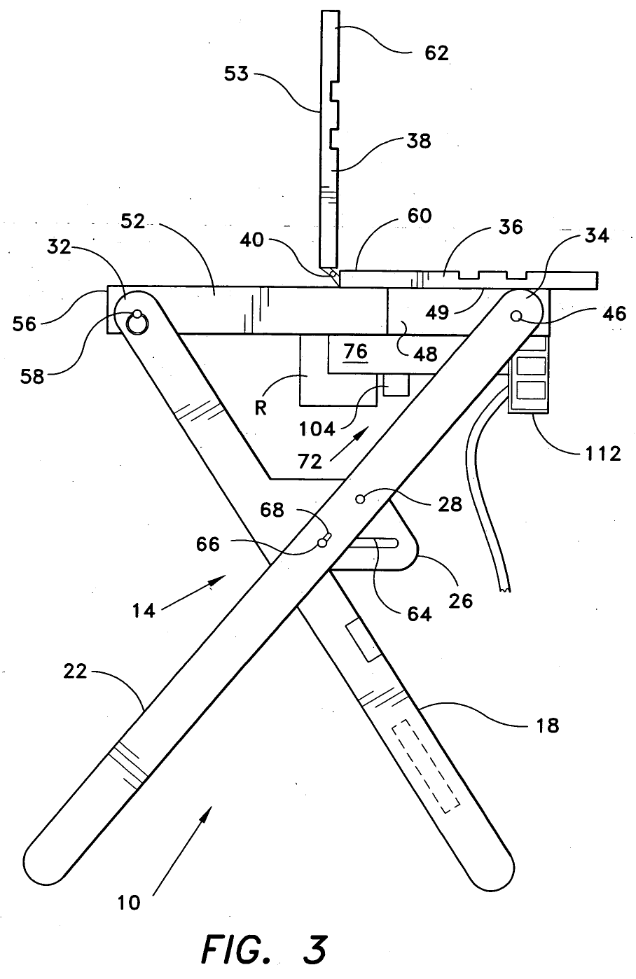

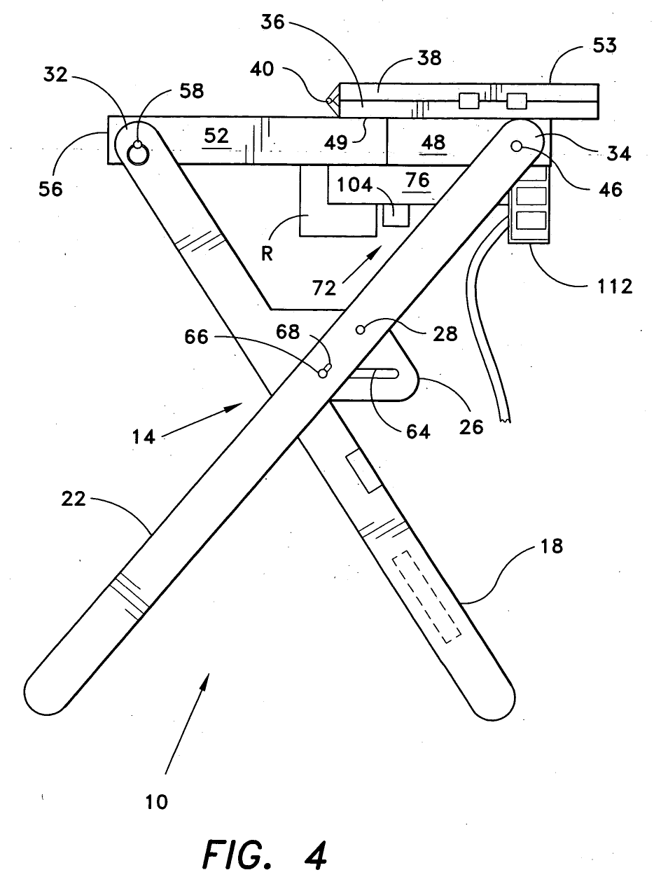

The table top support end 32 of the guide channel legs 16 and 18, and corresponding table top support ends 34 of the brace legs 20 and 22, support a folding table top thereon. The table top comprises two generally equal portions 36 and 38, with the two portions 36 and 38 secured together by a series of hinges 40 (shown in FIGS. 3 and 4). The hinges 40 are of a type which compensates for the thickness of the two panels 36 and 38 to allow the two table top portions 36 and 38 to fold 180 degrees.

The first table top panel or portion 36 is permanently and immovably affixed to a pair of substantially parallel fixed rails, respectively 42 and 44, which are in turn pivotally affixed to the table top support ends 34 of their respective brace legs 20 and 22 by pins 46. (A spacer block 48 is also affixed toward each end of the lower surface 49 of the first table top portion 36 and coplanar with the respective guide channel legs 16 and 18, to compensate for the thickness of their guide channel legs 16 and 18.) Each of the two table top support fixed rails 42 and 44 in turn have a table top support slide rail, respectively 50 and 52, extending therefrom, immediately outboard thereof and between their respective first rails 42 and 44 and spacer blocks 48. The two slide rails 50 and 52 are attached to their respective first rails 42 and 44 by longitudinal slide tracks, similar to desk drawer slides and the like, which are conventional in their construction and not shown in the drawing Figs.

The two slide rails 50 and 52 support the second table top portion 38 when the table assembly 10 is fully deployed as shown in FIG. 1 of the drawings. The second table top portion 38 is not affixed to the two slide rails 50 and 52, or to any other underlying structure, but merely rests with its lower surface 53 atop the slide rails 50 and 52 when the table 10 is fully deployed. This allows the second table top portion 38 to be hinged away from the two slide rails 50 and 52 as desired to alter the configuration of the table assembly 10, or to initiate the folding process as described further below. Each of the two slide rails 50 and 52 has a distal end, respectively 54 and 56, which is slidingly secured within the guide channel 30 formed in each of the two guide channel legs 16 and 18. The distal ends 54 and 56 of the two slide rails 50 and 52 are removably affixed to the table top ends 32 of their respective guide channel legs 16 and 18 by removable pins 58, visible in the side elevation views of FIGS. 3 and 4.

The progressive folding operation of the table 10 is illustrated in FIGS. 1 through 5 of the drawings. In FIG. 1, the table 10 is shown in its fully deployed condition, ready for use. FIGS. 2 and 3 illustrate an alternative configuration for the table 10, which also comprises the first step in the folding operation. In FIGS. 2 and 3, the second table top portion 38 is shown folded upwardly to form substantially a ninety degree angle with the first table top portion 36, which is immovably affixed to the two fixed rails 42 and 44. In this configuration, the second table top portion 38 serves as a guide fence for a workpiece being worked by the tool (router, or alternatively some other power tool) mounted beneath the table top portions 36 and 38.

In FIG. 4, the second table top portion 38 has been folded completely over to rest atop the first table top portion 36, with their two upper surfaces (60 for the first portion 36 and 62 for the second portion 38) facing and in contact with one another. This is permitted by the specific hinge 40 type used to secure the two table top portions 36 and 38 together, known as an “invisible hinge,” with its hinge line disposed below the two upper surfaces 60 and 62 of the table top portions 36 and 38 when the table top portions 36 and 38 are in their fully opened position. Such hinges may be provided by the Universal Industrial Products Company, and are available commercially.

At this point, the two slide rail guide leg pins 58 are removed from the table top support ends 32 of their respective guide legs 18 and 20 and the respective distal ends 54 and 56 of the corresponding slide rails 50 and 52, and the slide rail distal ends 54 and 56 are slid along the guide channels 30 of their respective guide channel legs 16 and 18, to the lower ends of those channels 30 in the brace leg extension 26 which extends generally medially from each of the two guide channel legs 16 and 18. The slide rail distal ends 54 and 56 are secured within the guide channels 30 of their respective guide channel legs 16 and 18 by forming the channels 30 to have a dovetail cross section, i.e. a conical cross section with the wider portion at the bottoms of the slots or channels 30. A slide pin (not shown) having a shape corresponding to the cross sectional shape of the channels 30, i.e. similar to the shape of a flat head screw or rivet for use in a countersunk hole, extends from each of the slide rail distal ends 54 and 56 and is captured within the channel 30 of the corresponding guide channel legs 16 and 18. It will be seen that other channel and slide pin shapes may be used as desired, e.g. T-sections, etc., to secure the slide rail distal ends 54 and 56 to their corresponding guide channel legs 16 and 18 while still allowing those slide rail distal ends 54 and 56 to slide along their respective guide channels 30.

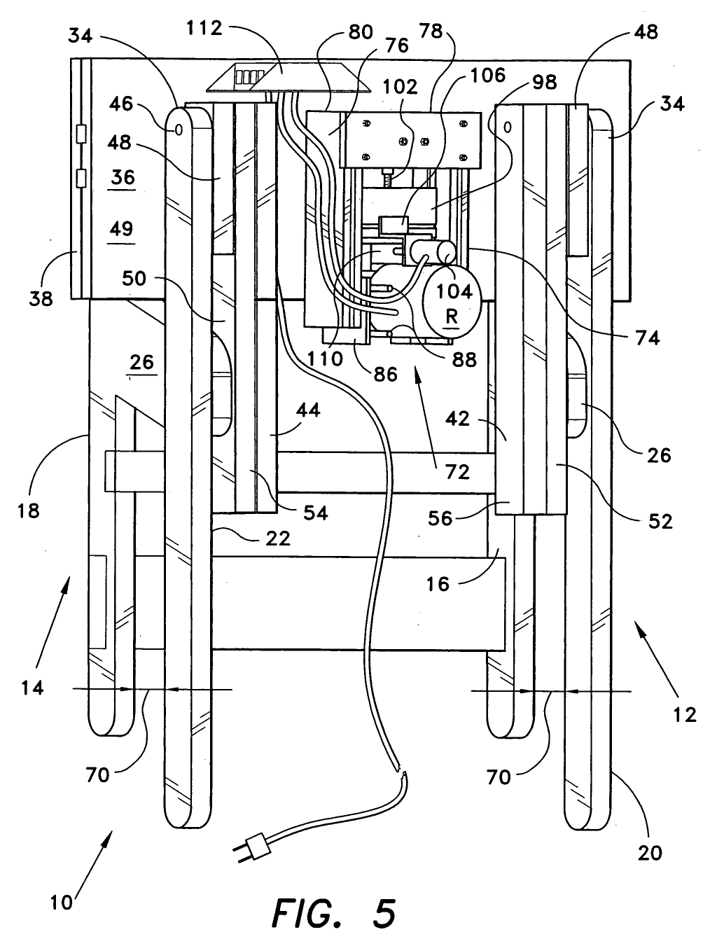

The two slide rails 50 and 52 remain parallel to their respective fixed rails 42 and 44 at all times, and the fixed rails 42 and 44 are permanently and immovably affixed to the lower surface 49 of the first table top portion 36. It will thus be seen that the first table top portion 36 swivels or pivots to lie essentially parallel to the two brace legs 20 and 22 as the distal ends 54 and 56 of the two corresponding slide rails 50 and 52 travel to the ends of the guide channels 30 of the two guide channel legs 16 and 18 to position the slide rails 50 and 52 essentially parallel to the brace legs 20 and 22 when the assembly is folded, as shown in FIG. 5.

Simultaneously with this action, the two slide rails 50 and 52 are retracted between their respective fixed rails 42 and 44 and corresponding spacer blocks 48. This also results in the guide channel leg and brace leg of each leg pair 12 and 14, pivoting together to narrow the space therebetween. Each brace leg 20 and 22 is pivotally secured to its respective guide channel leg 16 and 18 by a pivot pin 28 extending from each brace leg attachment extension 26, as described further above. A limit slot 64 is provided through each brace leg attachment extension 26, with a limit pin 66 passing through each brace leg 20 and 22 and through the corresponding limit slot 64. This arrangement limits the angular spread of the brace leg and guide channel leg of each leg pair 12 and 14, both in the fully deployed position shown in FIGS. 1 through 4 and the completely folded position shown in FIG. 5. As the limit slots 64 are formed as straight lines with their central portions closer to their respective pivot pins 28 than their ends, each limit pin 66 rides in a short slot 68 formed in its respective brace leg 20 and 22 to compensate for the difference in spacing from the pivot pin 28 at various points along each limit slot 64. Alternatively, the limit slots 64 could be formed as circular arcs with each point thereon being equidistant from the pivot pin 28, allowing the limit pins 66 to be immovably fixed relative to their respective brace legs 20 and 22, if so desired.

The distance or depth from the table top support ends 32 and 34 to the brace leg attachment extensions 26 of the guide channel legs 16 and 18 is considerably less than the full span of the two table top portions 36 and 38 when the two portions are fully deployed and coplanar with one another as illustrated in FIG. 1. As the first table top portion 36 folds to lie parallel to the two brace legs 20 and 22 when the table assembly 10 is folded, the second table top portion 38 lifts from the two slide rails 50 and 52 upon which it rests when the table 10 is fully deployed, to ride down the two guide channel legs 16 and 18. This has the effect of folding the two table top portions 36 and 38 together with their upper surfaces 60 and 62 in facing contact with one another, if the second table top portion 38 has not previously been folded over the first table top portion 36.

The offset of the brace leg pivot pins 28 from the longitudinal centerlines of the two guide channel legs 16 and 18 by means of the laterally offset brace leg attachment extensions 26, results in a space sufficiently wide to provide a table top storage area 70 between each guide channel leg 16, 18 and its corresponding brace leg 20, 22 when the corresponding legs 16, 20 and 18, 22 are folded to lie essentially parallel to one another. As the first table top portion 36 pivots to lie essentially parallel to the two brace legs 20 and 22 by means of the fixed and sliding rails 42, 44, 50, and 52, as explained further above, the second table top portion 38 also folds inwardly into the table top storage area 70 between the two legs forming each of the leg pairs 12 and 14, with the upper surfaces 60 and 62 of the two table top portions 36 and 38 in facing contact with one another, and with their opposite lower surfaces 49 and 53 facing outwardly, generally as shown in FIG. 5 of the drawings. This provides an elegant means of folding the assembly 10 when a power tool, such as the router R depicted in the drawing Figs., is installed beneath the table top portions 36 and 38, as is conventional in such devices. Using the folding system of the present table assembly 10, the router R and its attachments extend outwardly away from the center of the folded structure, and need not be removed from the structure for folding, as is the case in many power tool tables of the prior art.

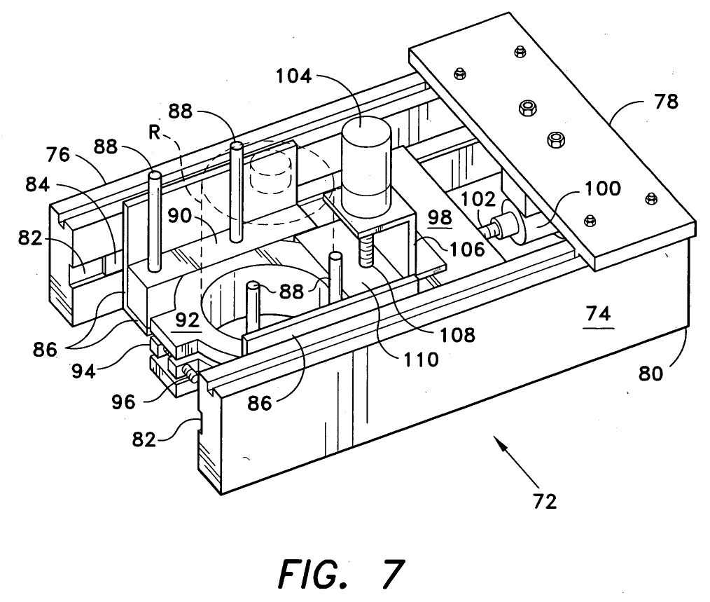

FIGS. 2 through 5 show the power tool attachment and positional adjustment mechanism 72 secured beneath the first table top portion 36, with FIG. 7 providing a detailed bottom perspective view of the mechanism 72. In FIG. 7, a pair of spaced apart, parallel guides, respectively 74 and 76, are immovably affixed to the bottom surface of the first table top portion 36 (not shown in FIG. 7, but shown in FIGS. 2 through 5). A base plate 78 is immovably affixed across the first ends 80 of the two fixed guides 74 and 76, providing for the attachment of a positional adjustment mechanism described further below. Each of the fixed guides 74 and 76 includes a guide channel 82 formed therein, with a moving guide track 84 installed in each channel 82. (While only a single one of paired components may be illustrated in the various drawing Figs., it will be understood that the power tool attachment and adjustment mechanism 72 is laterally symmetrical.)

Each of the moving guide tracks 84 has a moving guide bracket 86 affixed thereto and extending inwardly therefrom, i.e., toward one another. The two guide brackets 86 are formed of angle stock and have generally L-shaped sections, and are in mirror image to one another. The inwardly directed arms of the brackets 86 include a plurality of parallel slide pins 88 extending therefrom, with the pins 88 disposed normal to the inwardly directed arms of the brackets 86 and also normal to the guide channels 82 and their tracks 84.

Each of the guide brackets 86 has a guide block 90 installed thereon, with the guide blocks 90 sliding upon the pins 88 extending from the inwardly directed arms of their respective brackets 86. A power tool attachment fixture 92 is affixed between the two guide blocks 90. The fixture 92 illustrated generally comprises a circular bracket or collar, configured for surrounding and securing a router R therein. A tangential pinch clamp 94 and locking bolt 96 are provided at one side of the fixture 92, for securing the router R (or other tool) within the fixture 92 and positional adjustment mechanism 72. However, it will be readily apparent that the power tool attachment fixture may have other configurations for securing a table saw or other tool beneath the table, as desired. As the guide blocks 90 may slide upon the series of slide pins 88, and the slide pins 88 extend from the brackets 86 which are in turn affixed to the tracks 84 which slide in the guide channels 82 of the two opposed fixed guides 74 and 76, it will be seen that the tool attachment fixture 92 is capable of movement in either or both of two mutually orthogonal directions.

The power tool attachment fixture 92 is driven by means of two separate positional adjustment mechanisms, as described below. A lateral slide plate 98 extends between the two fixed guides 74 and 76, and slides within the tracks 82 of the guides 74 and 76. The slide plate 98 is driven by a first positional adjustment device 100, which is affixed to the base plate 78 which extends across the first ends 80 of the two fixed guides 74 and 76. The first positional adjustment device 100 may be an electric motor, as shown, or may alternatively be a manual crank, handle, or the like for manual operation of the mechanism. The device 100 is connected to and drives the slide plate 98 in the plane parallel to the lengths of the two fixed guides 74 and 76 by means of a first threaded rod 102 which extends from the motor or positional adjustment device 100 and threads into or through the slide plate 98, causing the slide plate 98 to advance or retreat along the channels 82 depending upon the direction of rotation of the first threaded rod 102.

A second positional adjustment device 104 (electric motor, or other drive mechanism as desired) is affixed to the slide plate 98, e.g. by a bracket 106, etc., and moves therewith when the slide plate 98 is moved by the first positional adjustment device 100. A second threaded rod 108 extends from the second adjustment device 104 and threads into or through an adjustment block 110, which is in turn affixed to the power tool attachment fixture 92.

The above described power tool attachment and adjustment mechanism provides linear positional adjustment of a power tool, e.g. the router R, secured therein in two mutually orthogonal directions, as noted further above. Actuation of the first positional adjustment device 100 rotates the first threaded rod 102 and drives the slide plate 98, and thus the adjustment block 110, linearly parallel to and beneath the first table portion 36 by means of the connection of the slide plate 98 to the adjustment block 110 due to the second positional adjustment device 104 and its threaded drive rod 108. As the adjustment block 110 is affixed to the power tool attachment fixture 92, the attachment fixture 92 and any tool secured therein (e.g., a conventional router R, etc.) slide parallel to the two fixed guides 74 and 76 by means of the attached guide blocks 90 and their attachment to the moving guide brackets 86 which extend inwardly from the tracks 84 of the fixed guides 74 and 76.

Actuation of the second positional adjustment device 104 results in rotation of the second threaded rod 108, which engages the adjustment block 110 to move it upwardly or downwardly relative to the plane of the two fixed guides 74 and 76, and thus the table top portion 38 to which they are attached. As the adjustment block 110 is affixed to the tool attachment fixture 92, which is in turn affixed to the two guide blocks 90 which slide on the slide pins 88, the entire assembly comprising the adjustment block 110, attachment fixture 92 and router R or other tool affixed therein, and guide blocks 90 are moved when the second adjustment device 104 is actuated.

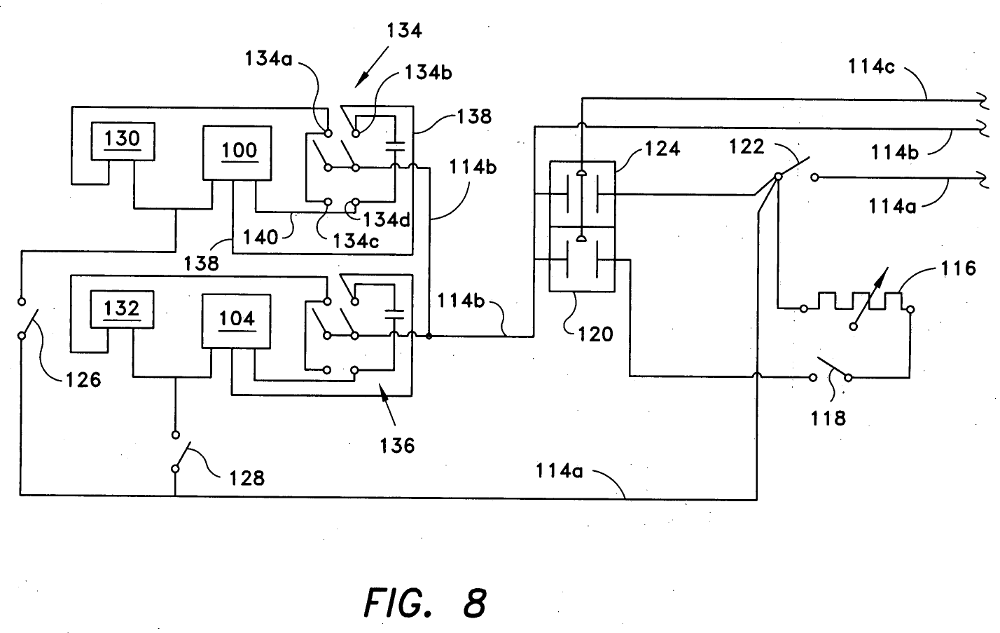

While the two positional adjustment devices 100 and 104 may comprise manually actuated rotary cranks, knobs, or the like, preferably the adjustment devices 100 and 104 are small electric motors actuated by appropriate switch mechanisms. FIG. 8 provides a schematic drawing of an exemplary switching circuit which may be used with the present invention. A switch or control box 112 is provided below the forward edge of the first table top portion 36, with the box 112 containing most of the circuitry illustrated in FIG. 8 and described below.

The circuit illustrated in FIG. 8 receives power conventionally, from a 115 volt household electrical line comprising conventional supply, return, and ground lines, respectively 114a, 114b, and 114c. The electrical supply line 114a supplies electrical power for a rheostat 116 and switch 118 (e.g., a normally open foot operated switch, or other type of switch as desired) which are wired in series with a receptacle 120 to which the router R or other power tool may be plugged. A master switch 122 is preferably provided in the circuit, to remove power from the circuit when not in use. The conventional on/off switch on the power tool may be left in the on position, with control of the tool being provided by the foot (or other) switch 118 and speed control rheostat 116 once the master switch 122 has been closed. A secondary or auxiliary receptacle 124 may also be provided, with the auxiliary receptacle 124 bypassing the rheostat 116 and switch 118 to receive uninterrupted power, e.g. for a light, another tool, etc., as desired.

A pair of essentially identical parallel circuits is provided to operate the two motors 100 and 104 by means of first and second, normally open, momentary contact “jog” switches, respectively 126 and 128. These two switches 126 and 128 receive power from the electrical supply line 114a when the master switch 122 is closed. Alternatively, the positional adjustment motors 100 and 104 may comprise lower voltage devices, and may be powered by a step down transformer or by conventional electrical storage cells or batteries, if so desired. Closure of either of the normally open “jog” switches 126 and/or 128 results in actuation of the corresponding position adjustment motor 100 and/or 104, with the direction of rotation of the motor depending upon the position of other switches in the circuit.

Each motor 100 and 104 is actuated by a relay, respectively 130 and 132, with the rotational direction of each motor 100 and 104 controlled by a separate double pole, double toggle (DPDT) switch, respectively 134 and 136. The direction of motor rotation depends upon the position of the corresponding switch 134 or 136, as noted further above. As an example, assume the first motor 100 is to be operated to rotate in a first direction. Closure of the first DPDT switch 134 to close the contacts 134a and 134b results in electrical power actuating the first motor relay 130 (when the first “jog” switch 126 is also closed) as current flows through the first contact 134a to the return line 114b, to provide electrical power to the first motor 100 through the first relay 130. Power flows through the motor 100 to operate the motor, and is returned to the circuit by the return line 138 which connects to the second contact 134b of the first DPDT switch 134. When the contact 134b is closed, as will be the case when the first contact 134a is closed in the DPDT switch 134, current flows through the contact 134b to the return line 114b, thereby completing the circuit. Normally, the switch 134 will be closed to close either the first two contacts 134a and 134b, or the third and fourth contacts 134c and 134b, with the normally open first “jog” switch 126 remaining open.

Switching the first DPDT switch 134 to the opposite contacts 134c and 134d results in motor operation in the opposite direction. In this case, electrical current flows to the relay 130 (assuming the “jog” switch 126 is closed), thence to the third switch contact 134c via the jumper between the contacts 134a and 134c, where it passes through the closed contact 134c to the return line 114b to complete the circuit. The circuit for the motor 100 is completed via the simultaneously closed fourth switch contact 134d, which completes the circuit from the motor 100 to the return line 114b via the second motor return line 140. The motor 100 will thus rotate in either direction depending upon the position of the DPDT switch 134, when the “jog” switch 126 is closed.

The only time the first motor 100 is actuated is when the first “jog” switch 126 is momentarily closed, thereby causing the first motor 100 to run only so long as the “jog” switch 126 is closed. In this manner, the operator may select the direction of rotation of the first motor 100 by means of the first DPDT switch 134, and “bump” the position of the power tool (router R, etc.) in the direction desired by briefly closing the first “jog” switch 126. This enables the operator of the tool to position the tool extremely precisely, with such precision adjustment being far easier using the motorized control of the present system than when attempting to manually adjust the height of the power tool relative to the work surface and/or the position of a fence on the work table, as is done conventionally. An examination of the circuitry for the second motor 104 will show that the operation of the second motor circuit 104 is identical to that of the first motor 100, described above. Other switch types and/or circuitry may be incorporated alternatively as desired, e.g. DPDT switches having center off positions, thereby allowing the “jog” switches to be eliminated from the circuit.

In conclusion, the present portable folding table provides a most useful structure for supporting a power tool for use. The present table is particularly useful for the installation of a router or the like therewith, where the power tool is disposed beneath the table with only the cutting bit or working component of the tool extending above the upper surface of the table. Conventional tables and stands for such power tools either cannot be folded, or are cumbersome in their folding operation, and/or require the power tool to be removed from the table for folding. The present table, with the space provided between the offset legs for storage of the inwardly folded table top portions therebetween, orients any power tool or other component secured beneath the table to the outside of the table structure when it is folded, thereby permitting the folding action to take place with the tool remaining attached to the table structure.

The tool attachment mechanism, with its two way positional adjustment of the power tool attached thereto, provides further ease of operation for the present invention. The use of threaded drives for the two mutually orthogonal adjustment directions permits extremely fine positional adjustments to be made to the tool relative to the table surface. This is much easier than attempting to reposition a fence or other structure on the table top using conventional clamps and the like, as is known in the prior art. The operator using the present tool need only position the appropriate DPDT switch (for horizontal or vertical adjustment, as desired) to cause the motor to rotate in the appropriate direction, and close the “jog” switch to move the tool in the direction desired. Short, momentary closures of the “jog” switch result in very little movement of the tool, thus permitting extremely fine positional adjustment. The present portable folding table with its positionally adjustable tool attachment mechanism, will thus find great utility not only among home craftsmen and others with limited workspace, but with professionals who have need to travel to various jobsites with their tools and for whom quickly accomplished precision work is critical to their employment.

It is to be understood that the present invention is not limited to the embodiments described above, but encompasses any and all embodiments within the scope of the following claims.

1. A folding router table, comprising:
a first leg pair;
a second leg pair oppositely spaced from and generally parallel to said first leg. pair, each said leg pair having a guide channel leg with a laterally offset brace leg attachment extension extending therefrom, and a brace leg pivotally attached to said laterally offset brace leg attachment extension of each said guide channel leg;
each said guide channel leg and corresponding said pivotally attached brace leg defining a table top storage area therebetween when each said leg pair is folded with each said guide channel leg disposed substantially parallel to said corresponding pivotally attached brace leg;
each said guide channel leg and each said brace leg further including a table top support end;
each said guide channel leg further having an inboard side with a guide channel formed therein and extending from said table top support end, to and across said laterally offset brace leg attachment extension;
a fixed rail pivotally affixed to said table top support end of each said brace leg;
a slide rail slidingly secured to each said fixed rail, each said slide rail further having a distal end slidingly secured within a corresponding said guide channel of each said guide channel leg;
a first table top portion immovably affixed across each said fixed rail;
a second table top portion pivotally attached to said first table top portion and resting across each said slide rail when said distal end of each said slide rail is secured to said table top support end of a corresponding said guide channel leg in a table deployed position;
said first and said second table top portion each having an upper surface and a lower surface opposite said upper surface;
each said table top portion being stored within said table top storage area between each said guide channel leg and corresponding said pivotally attached brace leg when each said leg pair is folded, with each said table top portion folded together with said upper surface of each said table top portion in facing contact with one another;
a power tool positional adjustment mechanism affixed to and depending below said first table top portion, providing positional adjustment in mutually orthogonal first and second directions; and
a router affixed to said positional adjustment mechanism.

2. The folding router table according to claim 1, wherein said second table top portion defines a guide fence when folded normal to said first table top portion.

3. The folding router table according to claim 1, wherein said power tool positional adjustment mechanism further comprises:
a pair of spaced apart, parallel fixed guides immovably affixed to and depending from said first table top portion;
each of said fixed guides further including a guide channel formed therein and at least a first end;
a moving guide track disposed in each said guide channel;
a moving guide bracket affixed to and extending inwardly from each said moving guide track;
a plurality of parallel slide pins extending from each said moving guide bracket, normal to said each said guide channel and guide track;
a guide block slidingly disposed upon each said guide bracket, by means of said slide pins;
a power tool attachment fixture affixed between each said slidingly disposed guide block;
an adjustment block affixed to said power tool attachment fixture, normal to each said slidingly disposed guide block;
a base plate affixed to said first end of each of said fixed guides, and extending thereacross;
a first positional adjustment device affixed to said first base plate;
a lateral slide plate slidingly disposed between each said channel of said fixed guides, and extending thereacross;
a first threaded rod extending between said first positional adjustment device and said lateral slide plate;
a second positional adjustment device affixed to said lateral slide plate; and
a second threaded rod extending between said second positional adjustment device and said adjustment block, normal to said first threaded rod; whereby
actuation of said first positional adjustment device rotates said first threaded rod and moves said lateral slide plate with said adjustment block and said power tool attachment fixture attached thereto parallel to said fixed guides by means of each said guide block and corresponding said moving guide bracket, and actuation of said second positional adjustment device rotates said second threaded rod and moves said adjustment block with said power tool attachment fixture attached thereto normal to said fixed guides by means of each said guide block sliding upon said pins of a corresponding said moving guide bracket.

4. The folding router table according to claim 3, wherein said power tool attachment fixture comprises a tool surrounding collar with a tangential pinch clamp and bolt.

5. The folding router table according to claim 3, wherein said first and said second positional adjustment device each comprise an electric motor.

6. The folding router table according to claim 5, further including at least a first and a second switch controlling said first and said second positional adjustment device.

7. A portable folding table, comprising:
a table top folding support leg assembly;
a table top storage area disposed within said support leg assembly when said support leg assembly is folded;
a first table top portion; and
a second table top portion pivotally attached to said first table top portion, said first and said second table top portion each having an upper surface and a lower surface opposite said upper surface; and
wherein each said table top portion is stored within said table top storage area when said support leg assembly is folded, with each said table top portion folded together with said upper surface of each said table top portion in facing contact with one another.

8. The portable folding table according to claim 7, further including a power tool positional adjustment mechanism affixed to and depending below said first table top portion, providing positional adjustment in mutually orthogonal first and second directions.

9. The portable folding table according to claim 8, wherein said power tool positional adjustment mechanism comprises:
a pair of spaced apart, parallel fixed guides immovably affixed to and depending from said first table top portion;
each of said fixed guides further including a guide channel formed therein and at least a first end;
a moving guide track disposed in each said guide channel;
a moving guide bracket affixed to and extending inwardly from each said moving guide track;
a plurality of parallel slide pins extending from each said moving guide bracket, normal to said each said guide channel and guide track;
a guide block slidingly disposed upon each said guide bracket, by means of said slide pins;
a power tool attachment fixture affixed between each said slidingly disposed guide block;
an adjustment block affixed to said power tool attachment fixture, normal to each said slidingly disposed guide block;
a base plate affixed to said first end of each of said fixed guides, and extending thereacross;
a first positional adjustment device affixed to said first base plate;
a lateral slide plate slidingly disposed between each said channel of said fixed guides, and extending thereacross;
a first threaded rod extending between said first positional adjustment device and said lateral slide plate;
a second positional adjustment device affixed to said lateral slide plate; and
a second threaded rod extending between said second positional adjustment device and said adjustment block, normal to said first threaded rod; whereby
actuation of said first positional adjustment device rotates said first threaded rod and moves said lateral slide plate with said adjustment block and said power tool attachment fixture attached thereto parallel to said fixed guides by means of each said guide block and corresponding said moving guide bracket, and actuation of said second positional adjustment device rotates said second threaded rod and moves said adjustment block with said power tool attachment fixture attached thereto normal to said fixed guides by means of each said guide block sliding upon said pins of a corresponding said moving guide bracket.

10. The folding router table according to claim 9, wherein said power tool attachment fixture comprises a tool surrounding collar with a tangential pinch clamp and bolt.

11. The folding router table according to claim 9, wherein said first and said second positional adjustment device each comprise an electric motor.

12. The folding router table according to claim 11, further including at least a first and a second switch controlling said first and said second positional adjustment device.

13. The portable folding table according to claim 7, wherein said folding support leg assembly comprises:
a first leg pair;
a second leg pair oppositely spaced from and generally parallel to said first leg pair;
each said leg pair comprising a guide channel leg with a laterally offset brace leg attachment extension extending therefrom, and a brace leg pivotally attached to said laterally offset brace leg attachment extension of each said guide channel leg;
each said guide channel leg and corresponding said pivotally attached brace leg defining said table top storage area therebetween when each said leg pair is folded with each said guide channel leg disposed substantially parallel to said corresponding pivotally attached brace leg;
each said guide channel leg and each said brace leg further including a table top support end;
each said guide channel leg further including an inboard side with a guide channel formed therein and extending from said table top support end, to and across said laterally offset brace leg attachment extension;
a fixed rail pivotally affixed to said table top support end of each said brace leg;
a slide rail slidingly secured to each said fixed rail;
each said slide rail further having a distal end slidingly secured within a corresponding said guide channel of each said guide channel leg;
said first table top portion being immovably affixed across each said fixed rail; and
said second table top portion being hingedly attached to said first table top portion and resting across each said slide rail when said distal end of each said slide rail is secured to said table top support end of a corresponding said guide channel leg in a table deployed position.

14. A folding router table, comprising:
a first table top portion;
a second table top portion, pivotally attached to said first table top portion, said first and said second table top portions each having an upper surface and a lower surface opposite said upper surface;
a power tool positional adjustment mechanism affixed to and depending below said first table top portion, providing positional adjustment in mutually orthogonal first and second directions; and
a router affixed to said positional adjustment mechanism.

15. The folding router table according to claim 14, further including:
a first leg pair;
a second leg pair oppositely spaced from and generally parallel to said first leg pair;
each said leg pair comprising a guide channel leg with a laterally offset brace leg attachment extension extending therefrom, and a brace leg pivotally attached to said laterally offset brace leg attachment extension of each said guide channel leg;
each said guide channel leg and corresponding said pivotally attached brace leg defining said table top storage area therebetween when each said leg pair is folded with each said guide channel leg disposed substantially parallel to said corresponding pivotally attached brace leg;
each said guide channel leg and each said brace leg further including a table top support end;
each said guide channel leg further including an inboard side with a guide channel formed therein and extending from said table top support end, to and across said laterally offset brace leg attachment extension;
a fixed rail pivotally affixed to said table top support end of each said brace leg;
a slide rail slidingly secured to each said fixed rail;
each said slide rail further having a distal end slidingly secured within a corresponding said guide channel of each said guide channel leg;
said first table top portion being immovably affixed across each said fixed rail;
said second table top portion being pivotally attached to said first table top portion and resting across each said slide rail when said distal end of each said second rail is secured to said table top support end of a corresponding said guide channel leg in a table deployed position; and
each said table top portion being stored within said table top storage area between each said guide channel leg and corresponding said pivotally attached brace leg when each said leg pair is folded, with each said table top portion folded together with said upper surface of each said table top portion in facing contact with one another.

16. The folding router table according to claim 15, wherein said second table top portion defines a guide fence when said second table top portion is folded normal to said first table top portion.

17. The portable folding table according to claim 14, wherein said power tool positional adjustment mechanism comprises:
a pair of spaced apart, parallel fixed guides immovably affixed to and depending from said first table top portion;
each of said fixed guides further including a guide channel formed therein and at least a first end;
a moving guide track disposed in each said guide channel;
a moving guide bracket affixed to and extending inwardly from each said moving guide track;
a plurality of parallel slide pins extending from each said moving guide bracket, normal to said each said guide channel and guide track;
a guide block slidingly disposed. upon each said guide bracket, by means of said slide pins;
a power tool attachment fixture affixed between each said slidingly disposed guide block;
an adjustment block affixed to said power tool attachment fixture, normal to each said slidingly disposed guide block;
a base plate affixed to said first end of each of said fixed guides, and extending thereacross;
a first positional adjustment device affixed to said first base plate;
a lateral slide plate slidingly disposed between each said channel of said fixed guides, and extending thereacross;
a first threaded rod extending between said first positional adjustment device and said lateral slide plate;
a second positional adjustment device affixed to said lateral slide plate; and
a second threaded rod extending between said second positional adjustment device and said adjustment block, normal to said first threaded rod; whereby
actuation of said first positional adjustment device rotates said first threaded rod and moves said lateral slide plate with said adjustment block and said power tool attachment fixture attached thereto parallel to said fixed guides by means of each said guide block and corresponding said moving guide bracket, and actuation of said second positional adjustment device rotates said second threaded rod and moves said adjustment block with said power tool attachment fixture attached thereto normal to said fixed guides by means of each said guide block sliding upon said pins of a corresponding said moving guide bracket.

18. The folding router table according to claim 17, wherein said power tool attachment fixture comprises a tool surrounding collar with a tangential pinch clamp and bolt.

19. The folding router table according to claim 17, wherein said first and said second positional adjustment device each comprise an electric motor.

20. The folding router table according to claim 18, further including at least a first and a second switch controlling said first and said second positional adjustment device.
